(19) United States
(12) Patent Application Publication
(10) Pub. No.: US 2026/0161527 A1
(43) Pub. Date: Jun. 11, 2026

(54) MODULAR DATA ORCHESTRATION PLATFORM

(71) Applicant: Microsoft Technology Licensing, LLC, Redmond, WA (US)

(72) Inventors: Haroon AHMED, Bellevue, WA (US); Bryce Garrett CUTT, Kelowna (CA); Avinash KOLLU, Bothell, WA (US); Theodore HOWARD, Seattle, WA (US)

(21) Appl. No.: 18/974,518

(22) Filed: Dec. 9, 2024

(51) Int. Cl. G06F 11/34; G06F 8/51; G06F 9/48

(52) U.S. Cl. CPC G06F 11/3476; G06F 8/51; G06F 9/4881

(57) ABSTRACT

A computing system executing a data orchestration platform is provided. The data orchestration receives a manifest file wherein the manifest file defines one or more data processing configuration parameters. The data orchestration platform generates orchestration logic based upon the manifest file. Upon execution of the orchestration logic and responsive to receiving a first data, the data orchestration platform generates a data record based upon the first data and identifies one or more tasks to be executed based upon the data record. A first task of the one or more tasks to a task queue and the data orchestration platform causes a first data processing module to execute the first task, wherein execution of the first task causes the data processing module to generate an output. The data orchestration platform then updates the data record based upon the output of the first data processing module.

### BACKGROUND

Modern computing systems generate and consume immense amounts of data. Organizing and managing data requires varying degrees of processing to manipulate the data into a format that is useful. In an example, in certain content moderation contexts, words or slogans are banned from display on a platform. Content indicative of the banned words or slogans therefore must be detected and removed. For textual data, the textual data needs to be processed (e.g., by way of a text comparator, etc.) to detect the presence of banned words or slogans. However, for other data, such as image data, the image data needs to be processed using multiple steps to detect if the banned words or slogans are present in the image data. In an example, image data can be processed (e.g., by way of optical character recognition, etc.) to detect textual data present in the image data. The textual data is then additionally processed to determine if the textual data is indicative of banned content (e.g., by way of the text comparator). For many types of data analysis, data needs to be separately processed by numerous computing systems before particular attributes of the data can be extracted. Such data processing requires substantial computing resources to maintain a proper data flow from receiving the data, processing the data, and/or storing the data according to a desired analysis plan.

For complex data processing applications, especially when data comes from multiple different sources, a simplified data processing pipeline can reduce computational resources needed to execute the data processing. A consolidated data processing pipeline where data can be organized, processed, and/or stored for later analysis reduces the resources needed to execute conventional data processing and improves the quality of the processed data. Data orchestration is a method by which different types of data and/or different sources of data can be consolidated into a more efficient data processing pipeline. Conventionally, data orchestration requires labor-intensive customization of individual data processing tools to handle specific data in a particular way. Each data analysis tool used to process data must be individually created and deployed, and any communication between separate tools requires further configuration and customization. The bespoke nature of conventional data orchestration systems is inflexible and burdensome to update, which limits its applicability in many data processing contexts, especially with respect to applications where frequent changes to how data is processed is required.

### SUMMARY

The following is a brief summary of subject matter that is described in greater detail herein. This summary is not intended to be limiting as to the scope of the claims.

Various technologies pertaining to a data orchestration platform are described herein. More specifically, the described data orchestration platform is configured to generate a data orchestration architecture for the processing of data according to a manifest file. The orchestration platform processes the data by way of one or more data processing modules initialized by the orchestration platform based upon the manifest file. In some examples, the manifest file is a human-readable file that defines one or more data processing configuration parameters. The data processing configuration parameters defined in the manifest file relate to how data is to be processed by the data orchestration platform (e.g., if data is “text” then process text to obtain an attribute of the text; if data is an image, then process the image to obtain an attribute of the image, etc.). The manifest file does not need to include detailed implementation instructions, just the parameters by which certain data should be processed. In an example, a manifest file may define parameters that describe how an image file should be processed, for example, detect text in the image and then identify if the detected text is indicative of a particular word or words.

When a manifest file is received by the data orchestration platform, the data orchestration platform generates orchestration logic based upon the manifest file. In some examples, the orchestration logic comprises computer executable source code, such that, when executed by a processor (e.g., a processor associated with the data orchestration platform), cause the processor to execute functions associated with the orchestration logic. In one example, the data orchestration platform comprises a control plane component that utilizes a manifest transpiler to interpret the parameters defined in the manifest file. In some examples, the manifest transpiler takes a first computer executable source code (e.g., within the manifest file) as input and generates a second computer executable source code as output. In some examples, the first computer executable source code is written in a first programming language, and the second computer executable source code output by the manifest transpiler is a second programming language.

In some examples, the data orchestration platform uses the output of the manifest transpiler to configure and generate the orchestration logic. Upon execution of the orchestration logic, the data orchestration platform causes data processing tasks to be executed by way of a data plane component and according to the orchestration logic (e.g., based upon the data processing configurations parameters defined in the manifest). In some examples, the data orchestration platform initializes one or more database instances in which the orchestration logic can be executed to execute the data processing tasks. In some examples, the data orchestration platform causes execution of the orchestration logic whereby a plurality of data processing tasks are executed in parallel. In certain examples, the data processing tasks are executed asynchronously.

The data orchestration platform receives data to process by way of one or more data sources. In some examples, one or more data sources may be associated with a data tenant. A data tenant is a corporation, organization, or the like, that generates, modifies, manages, and/or stores data. A data tenant may have several sub-tenancies, such as, for examples, customers that use a product or service of the data tenant and generate, modify, manage, and/or store data associated therewith.

The data orchestration platform receives data by way of a data plane component. In an example, the data plane component receives data associated with a data tenant that is the source of the manifest file (e.g., a client computing device). In some examples, the data received by the data plane component comes from one or more data sources internal and/or external to the data orchestration platform. In one example, the data plane component receives data by way of an input connector that is configured to interface with an external data source to retrieve data from the external data source. The connector may then provide the data to the data plane component executing the orchestration logic. Responsive to receiving data, the data orchestration platform generates a data record for the received data. For example, for a first data, a first data record is created, for a second data, a second data record is created, etc.

The data record comprises at least a portion of the data and an identifier. In some examples, the data record includes a universal resource locator (URL) address or other data link operable to point to a data source in which the data orchestration platform can retrieve data to be processed. In an example, the identifier comprises a timestamp indicative of a time at which the data was received by the data orchestration platform. In another example, the identifier describes the data associated with the data record, such as a location the data was generated, when the data was generated, who generated the data (e.g., a data tenant), a data type, data size, a data count, etc. The data record can be updated based upon data processing tasks that are executed on the data associated with the data record (e.g., by way of the data orchestration platform). Each time the data record is updated, the updated data record informs subsequent processing of the data by the data orchestration platform.

The data orchestration platform identifies one or more data processing tasks based upon the record and the manifest file. For example, the manifest file may define parameters for processing of image data to detect certain words (e.g., for purposes of content moderation, data privacy compliance, etc.). The data orchestration platform identifies tasks related to the parameters, for example, 1) execute image processing to detect textual data in the image, 2) process the resulting textual data to determine if the textual data comprises a word or words identified by the manifest file, etc. If the data record is indicative of image data (e.g., an image file, an image URL, etc.), the data orchestration platform adds a first image processing task to a task queue. The task queue defines required inputs and/or prerequisite data processing conditions for enqueued tasks. For example, for the above image processing task example, the task queue defines required inputs related to images (e.g., .jpeg, .gif, .pdf, image URL, etc.). In some examples, the task queue is managed by the data plane component.

As tasks are added to the task queue, the data orchestration platform causes a task to be executed by a data processing module that is configured to execute the task. For example, an optical character recognition module is configured to receive image data, execute optical character recognition on the image data, and generate an output indicative of recognized text within the image data. In another example, a classifier module receives input data, executes one or more pre-trained classifier models, and generates an output based upon the output of the one or more classifier models. In some examples, one or more data processing modules are stored in a module data store. In some examples, one or more data processing modules are generated by the data orchestration platform. In other examples, one or more data processing modules are external to the data orchestration platform. In certain examples, modules can be added and/or removed based upon the manifest file.

Each data processing module is configured to receive an input (e.g., a data record, data associated with the data record, etc.), execute a data processing task, and generate an output. In some examples, a record is updated based upon the output of the data processing module. The updated record is then analyzed by the data orchestration platform and a new task may be added to the task queue based upon the updated record and/or the manifest. The data orchestration platform continues to execute the data processing tasks on the task queue until there are no tasks remaining. In some examples, the data orchestration platform cause execution of the tasks by data processing modules asynchronously. By executing tasks asynchronously, the data orchestration platform enables computationally faster execution of data processing tasks compared to conventional technologies.

Exemplary operation of the described data orchestration platform is now described with reference to the following examples.

In a first example, a computing system comprises a processor and a memory, the memory storing instructions, that when executed by the processor, execute a data orchestration platform and related functionality. The data orchestration platform comprises a control plane component configured to generate orchestration logic based upon a manifest file (and/or output of a manifest transpiler). In some examples, the orchestration logic comprises computer executable source code generated by a logic generator component of the control plane component.

Continuing with the first example, data orchestration platform receives a manifest file, wherein the manifest file defines parameters for content moderation data processing. The data processing configuration parameters of the manifest file relate to processing image data to identify images banned words or slogans depicted in the image data. Responsive to receiving the manifest file, the data orchestration platform utilizes a manifest transpiler to interpret the parameters defined in the manifest file. The data orchestration platform generates orchestration logic (e.g., comprising computer executable source code) based upon the output of the manifest transpiler. The orchestration logic, when executed by the data orchestration platform causes execution of data processing tasks.

The data orchestration platform receives data by way of a data plane component. In some examples, the data plane component executes the orchestration logic. When the data plane component receives data to process, a data record is created for each item of received data. For example, for a first data, a first data record is created, for a second data, a second data record is created, etc. A data record comprises at least a portion of the associated data and an identifier. Continuing with the present example, the first data includes a universal resource locator (URL) address linking to an image data. The first record comprises the data (e.g., the image URL and/or the image data accessible at the image URL) and an identifier comprising a timestamp indicative of the time at which the data was received by the data orchestration platform. In another example, the identifier describes the data associated with the data record, such as a location that the data was generated, when the data was generated, who generated the data (e.g., a data tenant), a data type, data size, a data count, etc.

The data plane component analyzes the data record (e.g., according to the orchestration logic) and identifies one or more data processing tasks based upon the manifest file and the data record. In some examples, the data plane component analyzes the manifest file to identify the one or more tasks. In other examples, the data plane component identifies the one or more tasks based upon the orchestration logic which is generated based upon the manifest file. In both cases, the manifest file is used to determine what data processing tasks are to be executed by the data orchestration platform.

In the above example, because the first data record comprises an image URL related to image data processing, and the configuration parameters defined in the manifest file relate to content moderation, the data plane component determines the following data processing tasks, 1) execute image processing to detect text data in the image, and 2) process the resulting text to determine in the text comprises a word identified by the manifest file. The data plane component then adds the first task (e.g., execute image processing) to a task queue. The task queue defines required inputs and/or prerequisite data processing conditions for enqueued tasks. For example, inputs related to images may be associated with specific file types and/or data formats (e.g., .jpeg, .gif, .pdf, image URL, etc.). It is appreciated that in certain examples, more than one task can be enqueued to the task queue concurrently. If tasks can be performed independently (e.g., there are no dependencies between a first and subsequent tasks) multiple tasks can be enqueue to the task queue and processed by independently and/or asynchronously by different data processing modules.

The data plane component is associated with one or more connectors configured to manage the task queue and route queued tasks to appropriate data processing modules. In an example, an image processing connector dequeues the first image processing task mentioned above and assigns the task to an image processing module. The image processing module is configured to execute optical character recognition (OCR). When a task is assigned to a data processing module, the data processing module receives a data record and/or any data or portion thereof associated with the data record. In some examples, the connectors are generated as part of the orchestration logic. In other examples, one or more connectors may be stored in a connector data store and retrieved by the data plane component during execution of the orchestration logic.

In the above example, the image processing module receives the first data record comprising an image URL as input. The image processing module then retrieves the image located at the URL, executes OCR on the image, and generates an output result of the OCR (e.g., detected text within the image). In some examples, the connector retrieves the image at the image URL and provides the data record and the image data as input into the image processing module. The first data record is then updated based upon the output of the image processing module, for example, with text obtained as a result of executing OCR on the image from the image URL. The data orchestration platform analyzes the updated record and based upon the data in the updated record (e.g., the recognized text), adds a new task to the task queue.

The data orchestration platform (e.g., by way of the data plane component) determines from the updated data record that the new task can be executed by a text analysis module. The text analysis module is configured to analyze text and detect the presence of certain words or phrases. A connector dequeues the new task and provides the text analysis module with the updated record as input. The text analysis module processes the data associated with updated data record (e.g., text recognized as output of the OCR executed by the image processing module) and generates an output indicative of the presence of banned words or slogans. The data record is again updated and transmitted back to the data plane component.

The latest updated data record is analyzed by the data plane component and if there are additional data processing tasks to be executed (e.g., according to the orchestration logic and/or the manifest file) a new task will be added to the queue. If no additional tasks remain, the data orchestration platform waits until new data and/or a new and/or updated manifest file are received. If a new and/or updated manifest file is received, the data orchestration platform may modify existing orchestration logic to accommodate changes within the manifest file. Modules can be added and/or removed independently based upon changes to the manifest file.

In one example, the output generated by the text analysis module is indicative of one or more banned words identified by the manifest file. According to the updated data record, the data orchestration platform may generate an output indicative of the detected word to be transmitted back to the data tenant or source of the manifest file. In some examples, the data orchestration platform is configured to delete, remove, or otherwise modify the original data as a result of the data processing executed by the data orchestration platform. In one example, a new task is created based upon the latest updated record, in which a data processing module configured to execute the deletion, removal, and/or modification of the data can execute the action according to the task. The data orchestration platform continues to add tasks to the task queue according to the data records as they are updated based upon executed data processing tasks.

The technologies described above present a computationally faster and more efficient data orchestration compared to conventional technologies. Moreover, the presently described data orchestration technologies provide a platform that is flexible to accommodate changing data processing conditions. Accordingly, the technologies described herein solve a further deficiency of conventional data orchestration systems which require considerable manual resources to design, deploy, and maintain. More specifically, conventional data orchestration methodologies require significant customization for each data handling procedure. The high level of customization increases the complexity of the data orchestration and thus increases the resources needed to update or otherwise modify the orchestration.

The above presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary data orchestration computing environment.

FIG. 2 is functional block diagram illustrating aspects of an exemplary data orchestration platform control plane component.

FIG. 3 is a functional block diagram illustrating aspects of an exemplary data orchestration platform data plane component.

FIG. 4 is a functional block diagram of another exemplary data orchestration computing environment.

FIG. 5 illustrates an exemplary data orchestration methodology.

FIG. 6 illustrates and exemplary computing device for use with the technologies described herein.

Various technologies pertaining to a modular data orchestration platform are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be executed by multiple components. Similarly, for instance, a component may be configured to execute functionality that is described as being carried out by multiple components.

### DETAILED DESCRIPTION

Various technologies pertaining to a modular data orchestration platform are described in more detail herein. An exemplary data orchestration platform is configured to generate orchestration logic based upon a manifest file. When the orchestration logic is executed by a computing system, the orchestration logic causes certain data processing tasks to be executed (e.g., according to data processing configuration parameters defined in the manifest file). The data orchestration platform generates a data record for each received data. From the data record, certain data processing tasks are added to a task queue.

The data orchestration platform causes the tasks on the task queue to be executed by one or more data processing modules. In some examples, the tasks on the task queue can be executed asynchronously by the one or more data processing modules. The data processing modules receive the data record (and any associated data) as input and generate an output indicative of execution of the data processing task. The data record is then updated to reflect data processing task. The data orchestration platform analyses the updated record and determines if there are additional data processing tasks to be executed (e.g., according to the orchestration logic and/or the manifest file). If there are additional data processing tasks to be executed a new task will be added to the queue. If no additional tasks remain, the data orchestration platform waits until new data and/or a new manifest file are received. If a new manifest file is received, the data orchestration platform may modify existing orchestration logic to accommodate changes within the manifest file.

The above-described technologies present various advantages over conventional data processing technologies. For example, conventional data orchestration systems require substantial manual resources to design, deploy, and maintain. More specifically, conventional data orchestration requires significant customization for each data handling procedure. The high level of customization increases the complexity of the data orchestration and thus increases the difficultly when the system needs to be updated or otherwise modified. The data orchestration configured by the data orchestration platform is computationally more efficient than conventional technologies by reducing the complexity of the elements needed to execute data processing. Furthermore, the data orchestration platform further improves over conventional data processing technologies by providing a scalable and flexible platform more capable to adapt to changing data processing parameters.

Various technologies pertaining to a modular data orchestration platform as described herein are now described with reference to the drawings.

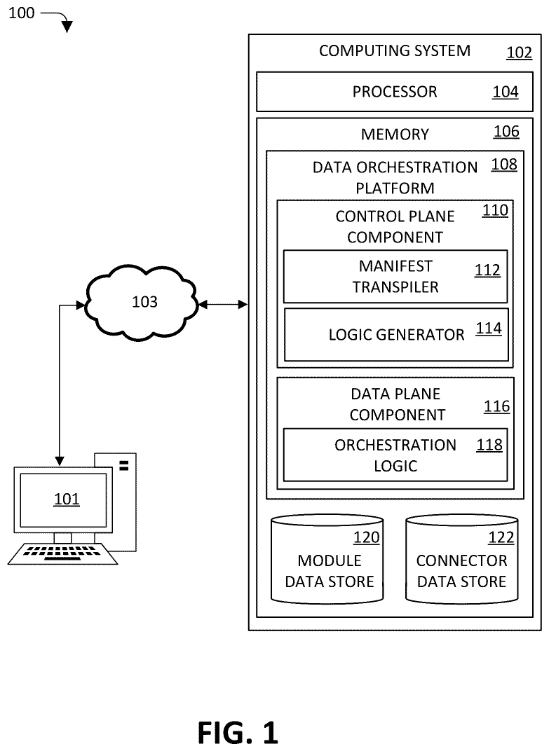

With reference to FIG. 1, an example computing environment 100 is illustrated. The computing environment 100 includes computing system 102 configured to facilitate data orchestration and execute (and/or cause execution of) data processing tasks. According to some examples, the computing system 102 is a server computing device. According to other examples, the computing system 102 is a cloud-based computing platform where component parts may be distributed among a plurality of computing system components. In some examples, computing system 102 may comprise one or more virtual machine components. The computing environment 100 further comprises a client computing device 101 that is in network communication with computing system 102 over a network 103 (e.g., the Internet, an intranet, or the like). According to further examples, the client computing device 101 and/or computing system 102 is a computing device operated by a user, such as a desktop computing device, a laptop computing device, a tablet computing device, a smartphone, a gaming console, a virtual reality computing device, an augmented reality computing device, or a wearable computing device.

The computing system 102 includes a processor 104 and memory 106. The memory 106 stores instructions, that when executed by the processor 104, cause the processor 104 to execute certain functionalities associated with computing system 102 and and/or its component parts. For example, memory 106 stores instructions related to a data orchestration platform 108, such that when the instructions are executed by processor 104, the processor executes acts associated with the data orchestration platform 108.

The data orchestration platform 108 comprises a control plane component 110 and a data plane component 116. The control plane component 110 is configured to analyze and interpret a data orchestration architecture based upon a manifest file. In some examples, the manifest file is a human-readable file that defines one or more data processing configuration parameters. The data processing configuration parameters defined in the manifest file relate to how data is to be processed by the data orchestration platform 108 (e.g., if data is “text” then process text to obtain an attribute of the text, if data is an image, then process the image to obtain an attribute of the image, etc.). In some examples, the manifest file is generated by client computing device 101 and transmitted to the data orchestration platform 108 by way of network 103. In some examples, the manifest file comprises computer-executable source code. In some examples, the orchestration platform 108 associates an intent with a manifest file. By comparing the intent across versions of a manifest file (e.g., as the manifest file is updated/modified/etc.) the orchestration platform 108 can detect specific changes within the manifest file and/or system operation, minimize disruptions during operation, make timely updates to a running orchestration and match intent during version updates. In some examples, the manifest file comprises natural language and rich visuals (e.g., dependency charts, data flows, call flows, etc.).

Control plane component 110 further comprises a manifest transpiler 112 and a logic generator 114. Manifest transpiler 112 is configured to interpret the parameters defined in the manifest file and produce an output to be used by the control plane component 110 to generate orchestration logic (e.g., orchestration logic 118) according to the manifest file. In some examples, the manifest transpiler 112 takes a first computer executable source code (e.g., within the manifest file) as input and generates a second computer executable source code as output. In a further example, the first computer executable source code (e.g., within the manifest file) is written in a first programming language, and the second computer executable source code output by the manifest transpiler is a second programming language. In some examples, the manifest transpiler 112 extracts information relating to the deployment of a data orchestration. For example, the manifest file may define parameters that indicate that the data orchestration platform 108 should process data within a particular external computing environment (e.g., a server associated with a data tenant).

The control plane component 110 provides the output of the manifest transpiler 112 as input into the logic generator 114. The logic generator 114 is configured to generate orchestration logic (e.g., orchestration logic 118) based upon the manifest file and/or the output of the manifest transpiler 112. In some examples, the logic generator 114 generates additional configuration and deployment instructions for execution of orchestration logic 118 within data plane component 112. In some examples, the logic generator 114 generates additional configuration and deployment instructions for execution of orchestration logic 118 within external database instance (e.g., based upon an output of the manifest transpiler 112). In further examples, the logic generator 114 may generate orchestration logic 118 based upon one or more data source parameters, for example, available network bandwidth, available computational resources, etc. In some examples, manifest transpiler 112 and logic generator 114 are combined, wherein the combined component is operable to execute all of the functionality described separately between manifest transpiler 112 and logic generator 114.

Data orchestration platform 108 further comprises data plane component 112. The data plane component 112 is configured to receive data and execute data processing tasks according to orchestration logic 118. Data plane component 112 receives data from one or more data sources. In some examples, the data plane component 112 receives data from an external computing system (e.g., client computing device 101). In some examples, one or more data sources may be associated with a data tenant. A data tenant is a corporation, organization, or the like, that generates, modifies, manages, and/or stores data. A data tenant may have several sub-tenancies, such as, for examples, customers that use a product or service of the data tenant and generate, modify, manage, and/or store data associated therewith. In an example, the data plane component receives data associated with a data tenant that is the source of the manifest file (e.g., a client computing device). In some examples, the data received by the data plane component 112 comes from one or more data sources (e.g., internal and/or external to the data orchestration platform). In a further example, data orchestration platform 108 receives data from a plurality of data tenants.

In some examples, the data plane 112 receives data by way of an input connector. One or more connectors may be generated by logic generator 114 to facilitate communication between data sources, data processing modules, and the data orchestration platform 108. In some examples, a connector is generated for each data processing module used by data orchestration platform 108. Responsive to receiving data, the data plane component 112 generates a data record for the received data. For example, for a first data, a first data record is created, for a second data, a second data record is created, etc. The data record comprises at least a portion of the data and an identifier. In some examples, the portion of the data included in the data record is a universal resource locator (URL) address or other data link operable to point to a data source in which the data orchestration platform can retrieve data to be processed. In an example, the identifier comprises a timestamp indicative of a time at which the data was received by the data orchestration platform. In another example, the identifier describes the data associated with the data record, such as a location the data was generated, when the data was generated, who generated the data, a data type, data size, a data count, etc. In another example, the identifier describes a data tenant (and/or sub-tenant). The data record can be updated based upon data processing tasks that are executed on the data associated with the data record (e.g., by way of the data orchestration platform 108). Each time the data record is updated, the updated data record informs subsequent processing of the data by the data orchestration platform 108.

Responsive to receiving data, the data plane component 112 executes (or causes execution of) the orchestration logic 118. During execution of the orchestration logic 118, certain data processing tasks are executed by way of one or more data processing modules. Each data processing module is configured to receive an input (e.g., a data record, data associated with the data record, etc.), execute a data processing task, and generate an output. In an example, a data processing module comprises one or more data processing models. An exemplary data processing model is a textual classifier. The textual classifier may be pre-trained to classify textual data. Data processing modules are configured to processing various types of data. In an example, data processing modules utilized by orchestration logic 118 comprise at least one of a textual data processing module, an image data processing module, a video data processing module, an audio data processing module, etc. In some examples, data processing modules are external to the data orchestration platform 108, but may still be used to perform data processing tasks.

In some examples, one or more data processing modules are stored in a module data store 120. Modules stored in module data store 120 may be retrieved during execution of the orchestration logic 118 to execute certain data processing tasks. In some examples, one or more data processing modules are generated by the data orchestration platform 108 (e.g., by way of logic generator 114). In further examples, one or more data processing modules are external to the data orchestration platform. External data processing modules operate substantially similar to other data processing modules such that they receive an input (e.g., a data record comprising data) and generate an output.

In some examples, the data plane component 112 and data processing modules communicate by way of one or more connectors. In some examples, connectors are generated by logic generator 114. In other examples, one or more connectors may be stored in a connector data store 122, and retrieved by the data plane component 112 during execution of the orchestration logic 118. While illustrated as individual data stores, it is appreciated that module data store 120 and/or connector data store 122 may be combined into a single data store. In some examples, module data store 120 and/or connector data store 122 are distributed amongst a plurality alternative data stores.

As will be described in greater detail below, the computing device 102, through the data orchestration platform 108 is generally configured to (1) receive a manifest file (e.g., from a client computing device 101) wherein the manifest file defines one or more data processing configuration parameters; (2) generate orchestration logic based upon the manifest file; (3) cause execution of the orchestration logic by way of a data plane component, wherein responsive to receiving a first data, the data plane executes acts based upon the orchestration logic; (4) generate a data record based upon the first data; (5) identify one or more tasks to be executed based upon the manifest file and the data record; (6) add a first task of the one or more tasks to a task queue; (7) cause a first data processing module to execute the first task, wherein execution of the first task causes the data processing module to generate an output; and (8) update the data record based upon the output of the first data processing module.

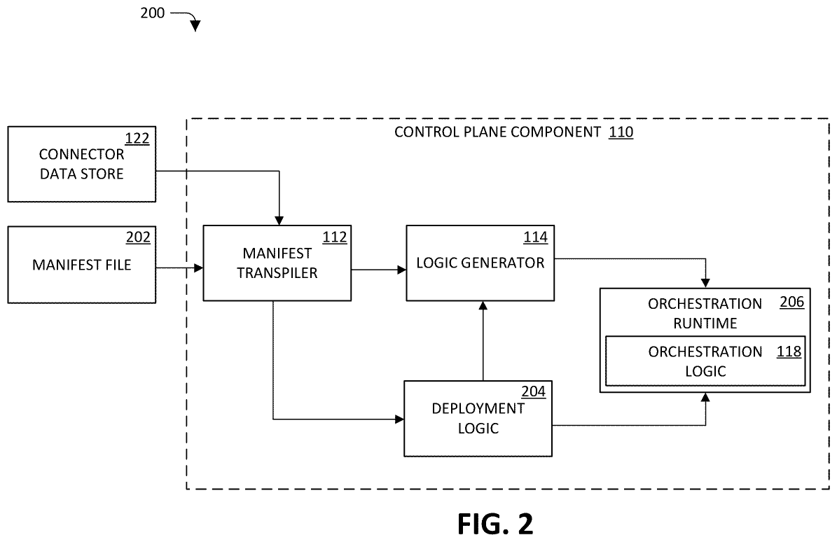

Referring now to FIG. 2, a functional block diagram illustrating an exemplary data processing flow 200 of the control plane component 110 is shown. Process flow 200 begins when control plane component 110 receives a manifest file 202. In some examples, the manifest file 202 is a human-readable file that defines one or more data processing configuration parameters. The data processing configuration parameters defined in the manifest file 202 relate to how data is to be processed by the data orchestration platform 108 (e.g., if data is “text” then process text to obtain an attribute of the text, if data is an image, then process the image to obtain an attribute of the image, etc.). The manifest file 202 does not need to include detailed implementation instructions, only the parameters by which certain data should be processed. In an example, a manifest file 202 may define parameters that describe how an image file should be processed, for example, detect text in the image and then identify if the detected text is indicative of a particular word or words. In some examples, the data processing configuration parameters of manifest file 202 comprise computer executable source code.

Control plane component 110 utilizes a manifest transpiler 112 to interpret the data processing configuration parameters defined in the manifest file 202. In some examples, the manifest transpiler 112 takes a first computer executable source code (e.g., within the manifest file 202) as input and generates a second computer executable source code as output. In some examples, the first computer executable source code is in a first programming language, and the second computer executable source code output by the manifest transpiler 112 is in a second programming language. In some examples, computer executable source code output by the manifest transpiler 112 may be further modified and integrated into computer executable source code associated with orchestration logic 118.

In some examples, the manifest transpiler 112 extracts information relating to the deployment of a data orchestration, which is output as deployment logic 204. For example, the manifest file may define parameters that indicate that the data orchestration platform 108 should process data within a particular external computing environment (e.g., a server associated with a data tenant). Deployment logic 204 may be further indicative of certain data orchestration deployment characteristics, such as a minimum or maximum amount of data records that can be processed in parallel, a minimum or maximum amount of computing resources that can be used for data processing, etc. In some examples, manifest transpiler 112 identifies one or more connectors needed to implement data processing configuration parameters define in the manifest file 202. Manifest transpiler 112 may then integrate instructions relating to the identified connectors into the output of the manifest transpiler which is used by the logic generator 114 to generate orchestration logic 118.

The control plane component 110 provides the output of the manifest transpiler 112 and/or the output of the deployment logic 204 as input into logic generator 114. Logic generator 114 is configured to generate orchestration logic 118. In some examples, the logic generator 114 generates computer executable source code, that when executed by a processor, causes the processer to execute orchestration logic 118. In some examples, manifest transpiler 112, deployment logic, 204, and logic generator 114 are combined, wherein the combined component is operable to execute all of the functionality described separately between manifest transpiler 112, deployment logic 204, and/or logic generator 114. The output of logic generator 114 and/or deployment logic 204 is used to execute orchestration runtime 206. Orchestration runtime 206 is representative of the execution of orchestration logic 118 at runtime (e.g., when orchestration logic 118 is executed at one or more computing systems).

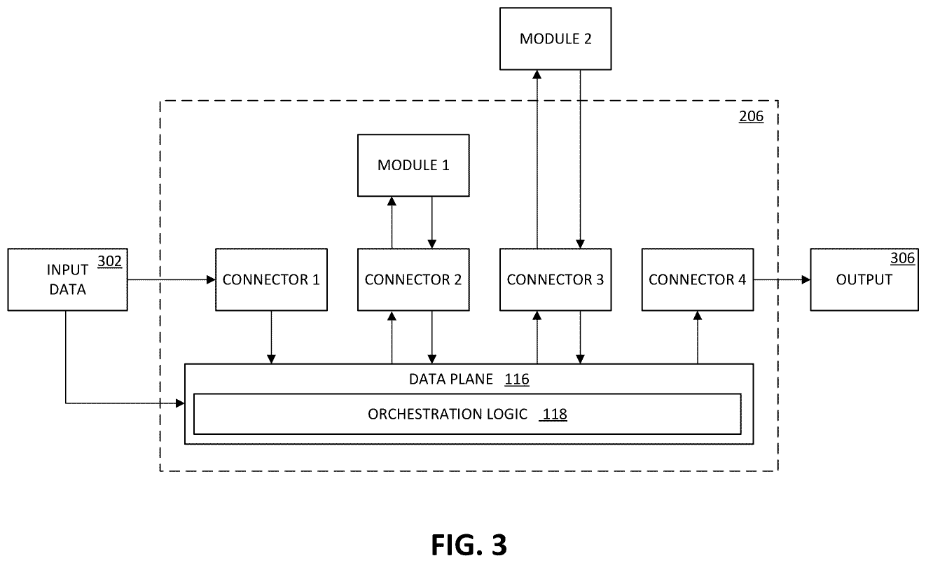

Referring now to FIG. 3, a functional block diagram illustrating an exemplary data processing flow 300 of a data orchestration platform 108 at runtime (e.g. orchestration runtime 206). It is appreciated that orchestration runtime 206 may be implemented within a computing system executing the data orchestration platform 108 (e.g., computing system 102). In some examples, the orchestration runtime 206 is implemented at an external computing system. The orchestration runtime 206 begins data orchestration actions upon receipt of input data 302. As described herein, the input data 302 comprise data from one or more data sources internal and/or external to the computing system executing the orchestration runtime 206. The input data 302 is received directly by data plane component 116 and/or by way of an input connector (connector 1). In some examples, an input connector formats input data 302 for processing by data plane component 116.

Responsive to receiving the data plane component receiving input data 302, the data plane component 116 executes acts based upon the orchestration logic 118. First, the data plane component 116 generates a data record based upon the input data 302. The data plane component 116 may process multiple units of data in parallel according to orchestration logic 118. In some examples, the data plane component 116 causes execution of data processing by a plurality of data processing modules asynchronously. In an example, where an input data comprises text and image data that require separate processing (e.g., based upon processing dependencies), the data plane component 116 may cause a textual data processing module and an image data processing module to execute data processing tasks independently. In some examples, the data plane component 116 is configured to scale data processing tasks according to the manifest file (e.g., by way of execution of the orchestration logic 118). For example, if the manifest file defines a parameter that textual data comprising 100 tokens is to be separately processed at a token level, the data plane component 116 may cause 100 textual data processing modules to process the textual data, etc. In some examples, the data plane component 116 automatically scales processing to handle incoming data load. Each data processing module can be scaled independently to optimize resource usage.

For each unit of data to be processed, the data plane component 116 generates an associated data record. For example, for a first data, a first data record is created, for a second data, a second data record is created, etc. Each data record comprises at least a portion of the first data (or a data link where the data or portion thereof can be retrieved) and an identifier. The identifier describes the data associated with the data record, such as the time the data was generated, a location that the data was generated, when the data was generated, who generated the data (e.g., a data tenant), a data type, data size, a data count, etc.

The data plane component 116 analyzes the data record (e.g., according to the orchestration logic 118) and identifies one or more data processing tasks to be executed (e.g., based upon the manifest file 202 and the data record). In some examples, the data plane component 116 analyzes the manifest file 202 to identify the one or more tasks. In other examples, the data plane component 116 identifies the one or more tasks based upon the orchestration logic 118 (which is generated based upon the manifest file). In both cases, the manifest file 202 is used to determine what data processing tasks are to be executed by the data orchestration platform 108. The data plane component 116 then adds a first task of the one or more tasks to a task queue. The task queue defines required inputs and/or prerequisite data processing conditions for enqueued tasks. For example, for an image processing task, the task queue defines required inputs related to images (e.g., .jpeg, .gif, .pdf, image URL, etc.). In some examples, the data plane component 116 places a plurality of tasks onto the task queue. The plurality of tasks can be executed asynchronously by a plurality of data processing modules.

The data plane component is associated with one or more connectors (e.g., connector 1, connector 2, connector 3, connector 4, etc.) configured to manage the task queue and route queued tasks to appropriate data processing modules. In some examples, the connectors are generated as part of the orchestration logic 118. In other examples, one or more connectors may be stored in a connector data store 122 and retrieved by the data plane component 116 during execution of the orchestration logic 118. In an example, connector 2 dequeues a first task mentioned above and assigns the task to a module 1.

In some examples, each connector is specially configured (e.g., by way of orchestration logic 118) to route a specific task from the task queue to a specific data processing module. For example, an image processing connector monitors the task queue for image processing tasks. When an image processing task is added to the task queue, the image processing connector verifies the appropriate input conditions are satisfied (e.g., image data, image URL, etc.) and assigns the task to an image processing module. In some examples, upon assigning a task to the appropriate data processing module, the connector provides the data record (and any associated data) as input into the data processing module. In some examples, the connector provides only the data as input into the data processing module.

Upon receiving the data record and/or associated data, the data processing module executes the first task from the first task queue, wherein the execution of the first task causes the data processing module to generate an output indicative of execution of the task. In some examples, an image processing module receives a first data record comprising an image URL as input. The image processing module then retrieves the image located at the URL, executes OCR on the image, and generates an output result of the OCR (e.g., detected text within the image). In some examples, a connector retrieves the image at the image URL and provides the image data (and/or data record) as input into the image processing module. In some examples, the output of the data processing module is provided back to a connector (e.g., the same connector that provided input into the data processing module). The data record is updated based upon execution of the task and the output of the data processing module. In some examples, the data record is updated by the data processing module, the connector, and/or the data plane component 116. The data plane component 116 analyses the updated record to determine if there is another task to add to the task queue.

Continuing with the example illustrated in FIG. 3, after module 1 executes a first task, the output of module 1 is passed back to connector 2, which was the same connector that assigned the first task to module 1. Connector 2 updates the data record in view of the output of module 1 and provides the updated data record to data plane component 116. Data plane component 116 analyses the updated data record and determines that a second task should be added the task queue. After the second task is added to the task queue, connector 3 dequeues the second task, and assigns the second task to module 2. Contrary to module 1, which was an internal data processing module (e.g., as retrieved from module data store 120 and/or a module generated by logic generator 114), module 2 is an external data processing module. In some examples, data orchestration platform 108 may interface with external data processing modules to execute certain data processing tasks. When external data processing modules are used, the data orchestration platform 108 may execute one or more additional data security measures during communication with the external data processing module (e.g., secure network connection, data encryption, etc.).

When module 2 executes the second task, connector 3 updates the data record based upon the output of module 2 and provides the updated record back to the data plane component 116. If the data plane component 116 determines that there are no more tasks to be performed based upon the updated data record, the data plane component 116 may generate an output 306 based upon the updated data record and the executed data processing tasks. In some examples, the data plane component 116 provides an output to an output connector (connector 4) which formats the output to be provided to an external computing system (e.g., client computing device 101). If no additional tasks remain, the orchestration runtime 206 waits until new data and/or a new manifest file are received. If a new manifest file is received, the data orchestration runtime 206 may modify existing orchestration logic 118 to accommodate changes within the manifest file. In some examples, when a new manifest file is received, the control plane component 110 will generate a new orchestration logic which can be deployed within an existing deployed orchestration runtime 304. In further examples, receipt of a new manifest file will trigger an entirely new orchestration runtime 304 to be generated and deployed. In some examples, a new manifest may cause the orchestration logic 118 to use different data processing modules or use existing data processing modules in a different order or sequence.

It is a further aspect of the described technologies that data orchestration platform 108 can be utilized for certain testing functions. For example, data orchestration platform 108 can perform A/B testing in which workflows can be distributed to a running data orchestration (control) and a suggestive improvement orchestration (treatment). In certain examples, testing distribution policies can be declared in the manifest and implemented in by way of the orchestration logic 118. In another aspect, orchestration platform 108 is configured to monitor active task queues and modify execution of the tasks based open operational limitations (e.g., desired rate of resource consumption, etc.). In another example, orchestration platform 108 is configured to monitor active task queues and modify execution of tasks based upon available system resources. For example, in the event that a data processing module has crashed and restarted, the orchestration platform 108 will dequeue tasks to be performed by the data processing module until the module is sufficiently operational. In further examples, orchestration platform 108 may perform periodic health checks on data processing modules (e.g., idle modules). Such monitoring may limit potential processing bottlenecks by detecting malfunctioning data processing modules before tasks are queued/dequeued. In some examples, orchestration platform 108 comprises an observation module to monitor system performance while a data orchestration is operational. In an example, an observation module comprises one or more pre-trained models configured to observe aspects of the orchestration runtime and system performance and suggest improvement measures. In a further example, an observation module may receive operational feedback (e.g., from a data tenant). The operational feedback can be used by the orchestration platform 108 to modify a manifest file, adjust system performance metrics, etc.

It is a further aspect of the described technologies that computing system 102 collects data related to the operation of the data orchestration platform 108. For example, operational telemetry relating to data plane 116 processing may be observed and/or logged, including, for example, workflow details, individual task execution, data record updates, etc. Additionally, computing system 102 may further observe/log changes in the control plane component 116 to as a result of manifest updates/changes, runtime environment operation, etc. The operational data collected by computing system 102 can be utilized for various purposes, for example, debugging for developers and/or operators, determining usage statistics and resource consumption metrics, data auditing for regulatory compliance and/or data security, transparency reporting (e.g., regulators and public), among others.

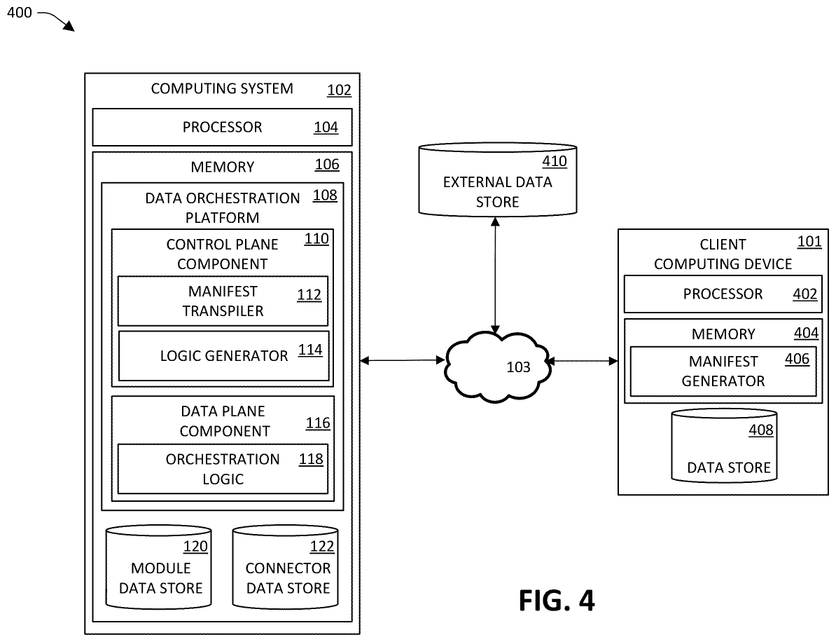

FIG. 4 illustrates a functional block diagram of another exemplary data orchestration computing environment 400. The computing environment 400 includes client computing device 101, computing system 102, and external data store 410. The client computing device 101, computing system 102, and external data store 410 are in communication by way of the network 103. The client computing device 101 may be a desktop computing device, a laptop computing device, a smartphone, a tablet, a virtual reality computing device, an augmented reality computing device, wearable computing device, or the like. The client computing device 101 includes input components that enable a user of the client computing device 101 to set forth input to the client computing device 101. The input components may include a mouse, a keyboard, a trackpad, a scroll wheel, a touchscreen, a camera, a video camera, a microphone, a controller, or the like.

As described herein, computing system 102 is configured to execute a data orchestration platform 108 to facilitate data processing tasks according to a manifest file (e.g., manifest file 202). A manifest file may be generated by way of client computing device 101. The client computing device comprises a processor 402 and a memory 404. Memory 404 comprises a manifest generator 406 configured to generate one or more manifest files. In some examples, manifest generator 406 is configured to generate the manifest file according to one or more data processing configuration parameters. In an example, the manifest generator 406 utilizes a user interface by which one or more data processing configuration parameters may be selected and implemented within a manifest file generated by the manifest generator 406. In some examples, prior generated manifest files may be stored in data store 408. In some examples, data store 408 stores client data (e.g., associated with a data tenant or sub-tenant). A user of client computing device 101 may select an existing manifest file from data store 408 and transmit to computing system 102 to initiate data processing by the data orchestration platform 108 according to the manifest file. In some examples, data processed by the data orchestration platform 108 is received from the external data store 410 and or data store 408.

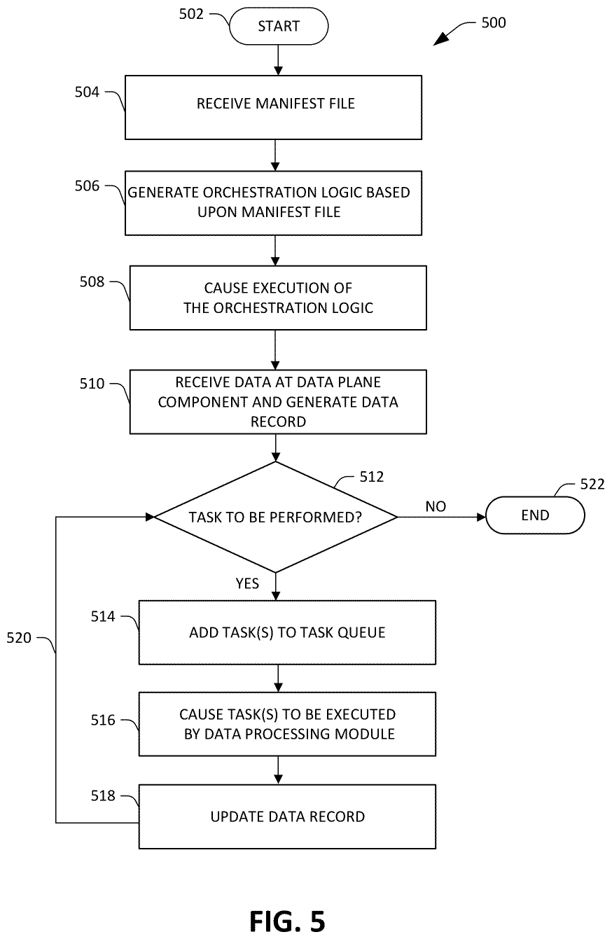

FIG. 5 illustrates an example methodology. While the methodology is shown and described as being a series of acts that are executed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement the methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

Referring now to FIG. 5, an example methodology 500 is illustrated. The methodology starts at step 502. At step 504 a manifest file is received. The manifest file comprises one or more data processing configuration parameters. In some examples, the manifest file is a human-readable file that defines one or more data processing configuration parameters. The data processing configuration parameters defined in the manifest file relate to how data is to be processed (e.g., by the data orchestration platform 108, for example, if data is “text” then process text to obtain an attribute of the text, if data is an image, then process the image to obtain an attribute of the image, etc.). The manifest file does not need to include detailed implementation instructions, only the parameters by which certain data should be processed. In an example, a manifest file may define parameters that describe how an image file should be processed, for example, detect text in the image and then identify if the detected text is indicative of a particular word or words. In some examples, the data processing configuration parameters of manifest file comprise computer executable source code.

At step 506, orchestration logic is generated based upon the manifest file. In some examples, the orchestration logic is generated based upon an output of a manifest transpiler (e.g., manifest transpiler 112). At 508, the methodology causes the orchestration logic (e.g., orchestration logic 118) to be executed. The orchestration logic may be executed at a computing system executing the data orchestration platform 108 (e.g., at computing system 102, by way of processor 104) or in some examples, may be executed at an external computing system.

At step 510, data is received at a data plane component (e.g. data plane component 116) and a data record is generated based upon the received data. At step 512, the methodology determines if a task is to be performed (e.g., based upon the data record). It is appreciated that in some examples, the methodology determines that a plurality of tasks are to be performed. Accordingly, in such examples, each task in the plurality of tasks may be processed according to the described methodology. In some examples, when it is determined that multiple tasks are to be performed, each task can be added to the task queue (e.g., step 514) and processed independently and asynchronously in parallel. In some examples, an identified task may be broken into several tasks with each task being adding to the task queue to be executed independently and asynchronously.

In an example, the first data record comprises an image URL related to image data processing, and the configuration parameters defined in the manifest file relate to content moderation. The data plane component 116 determines the following data processing tasks, 1) execute image processing to detect text data in the image, and 2) process the resulting text to determine in the text comprises a word or words identified by the manifest file. If the control plane component 116 identifies a task to be executed, a first task is added to a task queue at step 514. The task queue defines required inputs and/or prerequisite data processing conditions for enqueued tasks. For example, for image processing, required inputs are related to images (e.g., .jpeg, .gif, .pdf, image URL, etc.).

In some examples, the data plane component 116 is associated with one or more connectors configured to manage the task queue and route queued tasks to appropriate data processing modules. When a task is assigned to a data processing module, the data processing module receives a data record and/or any data or portion thereof associated with the data record. Responsive to receiving the data record (or data associated therewith) the data processing module is caused to execute the data processing task for which it is configured. In an example, an image processing module is configured to execute optical character recognition (OCR). When an image processing task is assigned to the image processing module, the module is configured to execute the task (e.g., execute OCR on the data associated with the data record). After the task is executed by the data processing module, the data record is updated based upon the output of the data processing module. In some examples, the data record is updated by a connector associated with the data processing module. In other examples, the data record is updated by the data plane component 116 when data output by the data processing module is received by the data plane component 116 (e.g., by way of a connector associated with the data processing module).

After the data record is updated at step 518, the methodology returns to step 512, where the data record is analyzed to determine if a task should be performed based upon the updated data record. If it is determined that a new task can be added to the task queue, the methodology repeats steps 514, 516, and 518 for the new task. It is appreciated that the methodology will repeat as long as there is another task to be added to the task queue based upon the updated data record. In some examples, a data processing module can only process a data record (or updated data record related thereto) one time. If at step 512, it is determined that there is no task to perform based upon the data record or updated data record (e.g., there are no data processing modules with appropriate inputs that have not already processed data associated with the data record), the data orchestration platform waits until new data and/or a new manifest file are received. After a timeout period (e.g., as defined by the manifest file or by orchestration logic 118) the methodology ends at step 522.

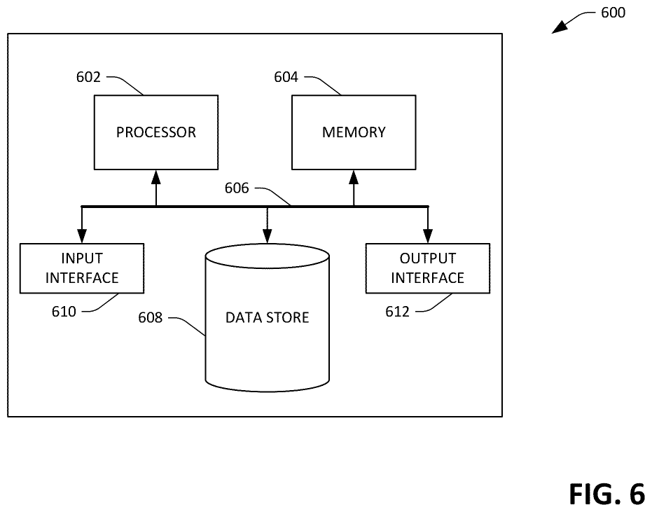

Referring now to FIG. 6, a high-level illustration of an example computing device 600 that can be used in accordance with the systems and methodologies disclosed herein is illustrated (e.g., computing device 101, computing system 102, etc.). The computing device 600 includes at least one processor 602 that executes instructions that are stored in a memory 604. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store keywords, classifiers, interaction data, and/or content.

The computing device 600 additionally includes a data store 608 that is accessible by the processor 602 by way of the system bus 606. The data store 608 may include executable instructions, computer-readable text that includes words, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

It is contemplated that the external devices that communicate with the computing device 600 via the input interface 610 and the output interface 612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 600 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 600 may be a distributed system. Thus, for instance, several devices may be in communication by way of a network connection and may collectively execute tasks described as being executed by the computing device 600.

The present disclosure relates to a modular data orchestration platform according to at least the following examples:

(A1) In one aspect, some embodiments include a method (e.g., 500) executed by a processor (e.g., 104) of a computing system (e.g., 102). The method comprises receiving a manifest file defining one or more data processing configuration parameters. The method additionally comprises generating orchestration logic based upon the manifest file. The method further comprises causing execution of the orchestration logic by way of a data plane component, wherein responsive to the data plane component receiving a first data, the data plane component executes acts based upon the orchestration logic. The acts executed by way of the data plane component comprise generating a data record based upon the first data, wherein the data record comprises at least a portion of the first data. The acts additionally comprise identifying one or more tasks to be executed based upon the manifest file and the data record. The acts further comprise adding a first task of the one or more tasks to a task queue. The acts additionally comprise causing a first data processing module to execute the first task from the task queue, wherein the execution of the first task causes the data processing module to generate an output. The acts further comprise updating the data record based upon the output of the first data processing module.

(A2) According to some embodiments of the method of A1, the method further comprises determining if the updated record is indicative of a second task to be executed, wherein if the updated record is indicative of a second task to be executed, adding the second task to the task queue.

(A3) According to some embodiments of any of the methods of (A1)-(A2), the method further comprises receiving a second data at the data plane component, wherein responsive to the data plane component receiving the second data, the data plane component executes additional acts based upon the orchestration logic. The additional acts comprise generating a second data record based upon the second data, wherein the second data record comprises at least a portion of the second data. The additional acts further comprise identifying a second task to be executed based upon the manifest file and the second data record. The additional acts further comprise adding the second task to the task queue. The additional acts additionally comprise causing a second data processing module to execute the second task from the task queue, wherein the execution of the second task causes the second data processing module to generate an output updating the second record based upon the output of the first data processing module.

(A4) According to some embodiments of any of the methods of (A2)-(A3), the first task is an image processing task and the first data processing module is an image processing module, and the second task is a textual processing module and the second data processing module is a textual processing module.

(A5) According to some embodiments of any of the methods of (A1)-(A4), one or more tasks are executed in parallel. In some embodiments the one or more tasks executed in parallel are executed asynchronously.

(A6) According to some embodiments of any of the methods of (A1)-(A5), the orchestration logic comprises computer executable source code generated based upon the manifest file.

(A7) According to some embodiments of any of the methods of (A1)-(A6), prior to causing the first data processing module to execute the first task from the task queue, the method further comprises dequeuing the first task by way of a connector configured to monitor the task queue and verify one or more input conditions.

(A8) According to some embodiments of any of the methods of (A1)-(A7), the data record additionally comprises an identifier, wherein the identifier comprises at least one of: a timestamp indicative of a time at which the first data was received; a location the first data was generated, when the first data was generated, an entity that generated the first data, a data type, a data size, or a data count.

(A9) According to some embodiments of any of the methods of (A1)-(A8), prior to generating orchestration logic, the method further comprises providing the manifest file as input into a manifest transpiler, wherein the manifest transpiler generates computer executable source code based upon the manifest file.

(A10) According to some embodiments of any of the methods of (A1)-(A9), the manifest file is obtained from a manifest file data store.

(B1) In another aspect, some embodiments include a computing system (e.g., 102) that includes a processor (e.g., 104) and memory (e.g., 106). The memory stores instructions that, when executed by the processor, cause the processor to execute any of the methods described herein (e.g., any of A1-A10).

(C1) In yet another aspect, some embodiments include a non-transitory computer-readable storage medium that includes instructions that, when executed by a processor (e.g., 104) of a computing system (e.g., 102), cause the processor to execute any of the methods described herein (e.g., any of A1-A10).

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, “model” and “system” are intended to encompass computer-readable data storage that is configured with computer-executable instructions that cause certain functionality to be executed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to execute acts comprising:
receiving a manifest file defining one or more data processing configuration parameters;
generating orchestration logic based upon the manifest file;
causing execution of the orchestration logic by way of a data plane component, wherein responsive to the data plane component receiving a first data, the data plane component executes acts based upon the orchestration logic, the acts comprising:
generating a data record based upon the first data, wherein the data record comprises at least a portion of the first data;
identifying one or more tasks to be executed based upon the manifest file and the data record;
adding a first task of the one or more tasks to a task queue;
causing a first data processing module to execute the first task from the task queue, wherein the execution of the first task causes the data processing module to generate an output; and
updating the data record based upon the output of the first data processing module.

2. The computing system of claim 1, further comprising:
determining if the updated record is indicative of a second task to be executed, wherein if the updated record is indicative of a second task to be executed, adding the second task to the task queue.

3. The computing system of claim 1, further comprising:
receiving a second data at the data plane component, wherein responsive to the data plane component receiving the second data, the data plane component executes acts based upon the orchestration logic, the acts comprising:
generating a second data record based upon the second data, wherein the second data record comprises at least a portion of the second data;
identifying a second task to be executed based upon the manifest file and the second data record;
adding the second task to the task queue;
causing a second data processing module to execute the second task from the task queue, wherein the execution of the second task causes the second data processing module to generate an output; and
updating the second record based upon the output of the first data processing module.

4. The computing system of claim 3, wherein the first task is an image processing task and the first data processing module is an image processing module, and the second task is a textual processing module and the second data processing module is a textual processing module.

5. The computing system of claim 3, wherein the first and second tasks are executed in parallel.

6. The computing system of claim 1, wherein the orchestration logic comprises computer executable source code generated based upon the manifest file.

7. The computing system of claim 1, wherein prior to causing the first data processing module to execute the first task from the task queue, dequeuing the first task by way of a connector configured to monitor the task queue and verify one or more input conditions.

8. The computing system of claim 1, wherein the data record additionally comprises an identifier, wherein the identifier comprises at least one of: a timestamp indicative of a time at which the first data was received; a location the first data was generated, when the first data was generated, an entity that generated the first data, a data type, a data size, or a data count.

9. The computing system of claim 1, wherein prior to generating orchestration logic, providing the manifest file as input into a manifest transpiler, wherein the manifest transpiler generates computer executable source code based upon the manifest file.

10. The computing system of claim 1, wherein the manifest file is obtained from a manifest file data store.

11. A method, the method comprising:
receiving a manifest file defining one or more data processing configuration parameters;
generating orchestration logic based upon the manifest file;
causing execution of the orchestration logic by way of a data plane component, wherein responsive to the data plane component receiving a first data, the data plane component executes acts based upon the orchestration logic, the acts comprising:
generating a data record based upon the first data, wherein the data record comprises at least a portion of the first data;
identifying one or more tasks to be executed based upon the manifest file and the data record;
adding a first task of the one or more tasks to a task queue;
causing a first data processing module to execute the first task from the task queue, wherein the execution of the first task causes the data processing module to generate an output; and
updating the data record based upon the output of the first data processing module.

12. The method of claim 11, further comprising:
determining if the updated record is indicative of a second task to be executed, wherein if the updated record is indicative of a second task to be executed, adding the second task to the task queue.

13. The method of claim 11, further comprising:
receiving a second data at the data plane component, wherein responsive to the data plane component receiving the second data, the data plane component executes acts based upon the orchestration logic, the acts comprising:
generating a second data record based upon the second data, wherein the second data record comprises at least a portion of the second data;
identifying a second task to be executed based upon the manifest file and the second data record;
adding the second task to the task queue;
causing a second data processing module to execute the second task from the task queue, wherein the execution of the second task causes the second data processing module to generate an output; and
updating the second record based upon the output of the first data processing module.

14. The method of claim 13, wherein the first task is an image processing task and the first data processing module is an image processing module, and the second task is a textual processing module and the second data processing module is a textual processing module.

15. The method of claim 11, wherein the first and second tasks are executed in parallel.

16. The method of claim 11, wherein the orchestration logic comprises computer executable source code generated based upon the manifest file.

17. The method of claim 11, wherein prior to causing the first data processing module to execute the first task from the task queue, dequeuing the first task by way of a connector configured to monitor the task queue and verify one or more input conditions.

18. The method of claim 11, wherein the data record additionally comprises an identifier, wherein the identifier comprises at least one of: a timestamp indicative of a time at which the first data was received; a location the first data was generated, when the first data was generated, an entity that generated the first data, a data type, a data size, or a data count.

19. The method of claim 11, wherein the manifest file is obtained from a manifest file data store.

20. A computer-readable storage medium comprising instructions that, when executed by a processor of a computing system, cause the processor to perform acts comprising:
receiving a manifest file defining one or more data processing configuration parameters;
generating orchestration logic based upon the manifest file;
causing execution of the orchestration logic by way of a data plane component, wherein responsive to the data plane component receiving a first data, the data plane component executes acts based upon the orchestration logic, the acts comprising:
generating a data record based upon the first data, wherein the data record comprises at least a portion of the first data;
identifying one or more tasks to be executed based upon the manifest file and the data record;
adding a first task of the one or more tasks to a task queue;
causing a first data processing module to execute the first task from the task queue, wherein the execution of the first task causes the data processing module to generate an output; and
updating the data record based upon the output of the first data processing module.
